(19) United States
(12) Patent Application Publication
(10) Pub. No.: US 2009/0164708 A1
(43) Pub. Date: Jun. 25, 2009

(54) MEMORY CHIP WITH EXTENDED INPUT/OUTPUT INTERFACE

(76) Inventor: Wei Cui, Shanghai (CN)

Correspondence Address: KNOBBE MARTENS OLSON & BEAR LLP, 2040 MAIN STREET, FOURTEENTH FLOOR, IRVINE, CA, 92614, US

(21) Appl. No.: 12/300,592

(22) PCT Filed: Mar. 12, 2007
(86) PCT No.: PCT/CN07/00781

§ 371 Date: Mar. 12, 2009

(30) Foreign Application Priority Data
May 11, 2006 (CN) 200610026444.8

(51) Int. Cl. G06F 12/02; G06F 13/00

(52) U.S. Cl. 711/103; 710/300; 711/E12.008

(57) ABSTRACT

A memory chip (1) with extended input/output interface is provided, for connecting to a host processor (11), wherein, a decoder (3), a counter (4) and a latch (5) is connected to each other in turn, then connected to an internal address bus interface (9) of a memory unit (2); a bus switch (7) is connected to an internal data bus interface of the memory unit (2); the decoder (3) is connected to the counter (4), the latch (5) and the bus switch (7) respectively; the bus switch (7) and the decoder (3) is connected to the host processor (11) through a memory data bus (6), the memory unit (2) and the decoder (3) receive a control signal sent from the host processor (11) through a control bus (10). An address counter is added in front of an address latch, automatic increment of the address is realized so as to enhance the access speed. The additional circuits including decoder (3), the latch (5), the bus switch (7) and the counter (4) etc. And the memory chip is integrated into a single chip, employing the extended manner of the input/output interface not only spares the address bus of the memory chip, but also simplifies the circuit, reduces the cost. Simultaneously, the access speed is increased and the number of the pins of the memory chip is saved.

### TECHNICAL FIELD

The present invention generally relates to the art of memory chips and, more particularly, to a memory chip with extended input/output ports.

### DESCRIPTION OF RELATED ART

A conventional memory chip is generally used as a read-write memory, a read-only memory, or a flash memory, which uses control bus, address bus and data bus to complete accessing.

However, in many cases, it is necessary to avoid the address bus provided by the host processor. Instead, input/output ports of the host processor are extended. At the same time, encoders, address-flip-latches, bus-switches and other components/circuits are additionally added in, which increases complexity and cost of the circuits. In addition, the amount of the leads of the memory chip is more than half of the amount of all the pins of the chip, which increases the cost of the memory chip.

Furthermore, after accessing each time, the host processor must re-latch the address in the address flip-latch. When accessing data blocks having continuous addresses, such as Chinese character database chip, the operation of re-latching the addresses is to increase the addresses, i.e., after accessing the data units every time, the host must increase the addresses, which depresses the accessing speed.

### SUMMARY OF THE INVENTION

The object of the present invention is to provide a memory chip including extended input/output ports, which enables avoiding the address bus and decreasing the amount of the leads of memory chip, simplify the exterior circuits and speedup accessing.

In one embodiment of the present invention, a memory chip with extended input/output ports, for connecting to a host processor and accessing data, includes a memory unit, an encoder, a counter, a flip-latch, and a bus switch. The encoder, the counter and the flip-latch are connected to each other in turn, and then connected to an internal address bus port of the memory unit. The bus switch is connected to an internal data bus port of the memory unit. The decoder is respectively connected to the counter, the flip-latch and the bus switch. The bus switch and the encoder are connected to the host processor through a memory data bus. The memory unit and the encoder receive controlling signals from the host processor via a controlling bus.

According to the memory chip with extended input/output ports mentioned above, the internal data bus, the internal address bus, the controlling bus, the encoder, the counter, the flip-latch, the bus switch, and the memory unit are integrated in one single memory chip.

According to the memory chip with extended input/output ports mentioned above, the controlling bus comprises read/write signals, chip-selection signals, and low order addresses in an address bus of the host processor.

According to the memory chip with extended input/output ports mentioned above, the counter enables automatically increasing the addresses.

According to the memory chip with extended input/output ports mentioned above, at least one address flip-latch counter is included.

According to the memory chip with extended input/output ports mentioned above, the memory chip is used as a read-write memory, a read-only memory, or a flash memory.

According to the memory chip with extended input/output ports mentioned above, data widths of the encoder, the counter and the flip-latch are same to the internal address widths of the memory unit.

According to the memory chip with extended input/output ports mentioned above, the host processor accesses the memory chip via the data bus and the controlling bus of the memory chip, and sends the address to the decoder via the data bus.

As an address counter is added before the address flip-latch, the addresses can be increased automatically, which enables increasing accessing speed. In the present invention, the decoder, the flip-latch, bus switch and the counter are integrated into a single memory chip, employing the extended manner of the input/output port without the address bus of the memory chip, which simplifies the circuits and decreases the cost. Simultaneously, the access speed is increased and the number of the pins of the memory chip is saved.

Other features and advantages of the present invention will become more apparent to those skilled in the art upon examination of the following drawing and detailed description of preferred embodiment.

### BRIEF DESCRIPTION OF THE DRAWINGS

FIG. 1 is an illustration of a memory chip having extended input/output ports according to the present invention.

### DETAILED DESCRIPTION OF THE PREFERRED EMBODIMENT

Reference will now be made to describe the preferred embodiment of the present invention in detail.

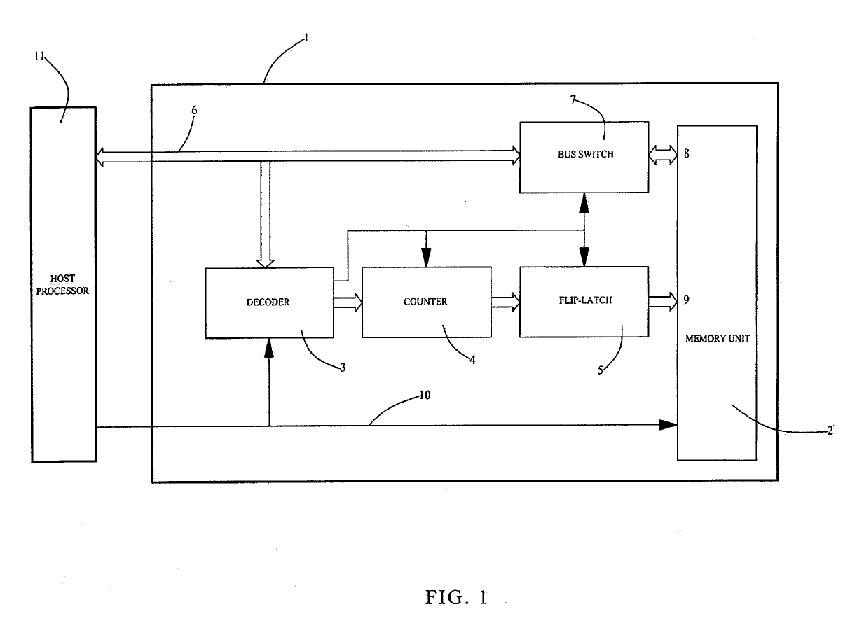

Referring to FIG. 1, a memory chip 1 with extended input/output ports includes a memory unit 2, a encoder 3, a counter 4, a flip-latch 5, a memory data bus 6, a bus switch 7, an internal data bus port 8, an internal address bus port 9, and a controlling bus 10.

The decoder 3, the counter 4 and the flip-latch 5 are connected to each other in turn, then connected to the internal address bus port 9 of the memory unit 2.

The bus switch 7 and is connected to the internal data bus port 8 of the memory unit 2.

Additionally, the encoder 3 is respectively connected to the counter 4, the flip-latch 5 and the bus switch 7.

The bus switch 7 and the encoder 3 is connected to the host processor 11 via the memory data bus 6.

The memory unit 2 and the encoder 3 receive controlling signals from the host processor 11 via controlling bus 10.

The memory unit 2 have a structure of a traditional memory and includes internal data bus 8, internal address bus 9 and controlling bus 10.

The additional circuit for extending the input/output port in the present invention, that is, The encoder 3, the counter 4, the flip-latch 5, the bus switch 6 and the memory unit 2 are integrated into a single chip, i.e. the memory chip 1 with extended input/output ports, which enable the memory chip 1 to be connected to the host processor 11 only via the data bus 6 and the controlling bus 10. Traditional address bus is omitted.

The hose processor 11 accesses the memory unit 2 via the memory data bus 6, the bus switch 7 and the internal data bus 8. At the same time, the host processor 11 sends the address to the encoder 3 via data bus 6.

The host processor 11 operates the counter 4, the address flip-latch 5 and the bus switch 7 via the controlling bus 8 and the encoder 3. At the same time, the host processor accesses the data in the memory unit 2.

Data widths of the encoder 3, the counter 4 and the flip-latch 5 are same to data widths of the internal address bus port 9 of the memory unit 2.

The controlling bus 10 comprises read/write signals and chip-selection signals. In addition, low order addresses in an address bus of the host processor 11 are sent to the encoder 3 via the controlling bus 10

When the host processor 11 accesses the memory unit each time, the counter 4 will increase the darresses automatically.

While the present invention has been described with reference to a specific embodiment, the description of the invention is illustrative and is not to be construed as limiting the invention. Various of modifications to the present invention can be made to the preferred embodiment by those skilled in the art without departing from the true spirit and scope of the invention as defined by the appended claims.

1. A memory chip with extended input/output ports, for connecting to a host processor and accessing data, the memory chip comprising:
a memory unit, an decoder, a counter, a flip-latch, and a bus switch;
wherein the decoder, the counter and the flip-latch are connected to each other in turn, then connected to an internal address bus port of the memory unit;
wherein the bus switch is connected to an internal data bus port of the memory unit;
wherein the decoder is respectively connected to the counter, the flip-latch and the bus switch;
wherein the bus switch and the decoder are connected to the host processor through a memory data bus; and
wherein the memory unit and the decoder are configured to receive controlling signals from the host processor via a controlling bus.

2. The memory chip with extended input/output ports as described in claim 1, wherein the internal data bus, the internal address bus, the controlling bus, the encoder, the counter, the flip-latch, the bus switch, and the memory unit are integrated into one single memory chip.

3. The memory chip with extended input/output ports as described in claim 1, wherein the controlling bus comprises read/write signals, chip-selection signals, and low order addresses in an address bus of the host processor.

4. The memory chip with extended input/output ports as described in claim 1, wherein the counter enables automatically increasing the addresses.

5. The memory chip with extended input/output ports as described in claim 1, further comprising at least one address flip-latch counter.

6. The memory chip with extended input/output ports as described in claim 1, wherein the memory chip is used as a read-write memory, a read-only memory, or a flash memory.

7. The memory chip with extended input/output ports as described in 1, wherein data widths of the encoder, the counter and the flip-latch are same to internal address widths of the memory unit.

8. The memory chip with extended input/output ports as described in claim 1, wherein the host processor is configured to access the memory chip via the memory data bus and the controlling bus, and is configured to send the address to the encoder via the data bus.
